(19) United States
(12) Patent Application Publication
(10) Pub. No.: US 2013/0113714 A1
(43) Pub. Date: May 9, 2013

(54) Electronic Device Having Single Hand Multi-Touch Surface Keyboard and Method of Inputting to Same

(71) Applicant: Dun Dun (Duncan) Mao, Burnaby (CA)

(72) Inventor: Dun Dun (Duncan) Mao, Burnaby (CA)

(21) Appl. No.: 13/290,104

(22) Filed: Nov. 6, 2011

(51) Int. Cl. G06F 3/041

(52) U.S. Cl. 345/173

(57) ABSTRACT

A multi-touch surface such as of a touch screen on a platform of an electronic device has a distribution of touch sensitive keys each corresponding to a letter, number, symbol or function. The keys are grouped into pads, each pad being operable by a different fingertip of the same hand. The locations of the pads may conform to a user's hand shape, size and position in relation to the screen, and is such that a single hand can comfortably be used for typing. A modified version of the key pattern can be used for smaller touch screens.

### TECHNICAL FIELD

This application relates to data entry interfaces for electronic devices. More particularly, it relates to an electronic device having a multi-touch surface configured as an application-independent keyboard for efficient use with a single hand.

### BACKGROUND

In modern mobile digital devices such as tablets, notebooks and cell phones, space is at a premium and use of a touch screen is almost universal. Electronic devices with multi-touch screens are often configured with QWERTY, AZERTY, DVORAK or other traditional keyboard layouts for accepting user inputs of text, numbers, characters and commands. The use of a multi-touch screen for text entry is often not as convenient as using a conventional keyboard because the user may need to hold the electronic device in one hand while typing with the other. Besides this, multi-touch screens usually present a smaller area than conventional keyboards, making for a somewhat cramped layout of the keys.

U.S. Pat. No. 7,057,607 discloses a user interface for a touch screen in which user inputs are categorized as either a swish type stroke or a non-swish type stroke. If the stroke is a non-swish, it is translated into an application function. If the stroke is a swish, it is converted in to a character.

U.S. Pat. No. 6,104,317 discloses a data entry device with input regions for receiving stroke inputs, where input regions have multiple characters indicated on them. Strokes are correlated with characters.

### SUMMARY OF INVENTION

The present invention is directed to any electronic device with a multi-touch surface that may be configured as a single-handed keyboard interface. It is also directed to a method in which the positions of the individual finger pads, representing screen character input areas, are automatically calibrated to the size and shape of the user's hand, as well as left or right hand use. Characters can be entered on the multi-touch surface by finger taps, short directional strokes, or combinations thereof.

Accordingly, an aspect of the present invention is an electronic device comprising a platform having a multi-touch surface configured with a single-hand keyboard; a memory storing computer readable instructions; and a processor connected to the memory and the multi-touch surface; the computer readable instructions configured, upon processing by the processor, to cause the device to: define a key pad at each of two or more locations on the multi-touch surface, wherein: each pad location corresponds to a different fingertip of a single hand; each pad comprises a plurality of touch sensitive keys; and each touch sensitive key is assigned to a character or a function; detect activation of a selected one of the touch sensitive keys; and register in memory the character or function corresponding to the selected one of the touch sensitive keys activated.

Another aspect of the present invention is a method for receiving inputs via an electronic device with a multi-touch surface, configured with a single-hand keyboard, connected to a processor, the processor, when acting upon computer readable instructions stored in a memory connected to the processor, causing the electronic device to perform the steps of: defining a key pad at each of two or more locations on the multi-touch screen, wherein: each location corresponds to a different fingertip of a single hand; each pad comprises a plurality of touch sensitive keys; and each touch sensitive key is assigned to a character or a function; detecting activation of each of the touch sensitive keys; and registering in memory the character or function corresponding to the touch sensitive key activated.

A further aspect of the present invention is an electronic device configured with a single-hand keyboard comprising: a platform having a multi-touch surface configured with a single-hand keyboard; a memory on the platform storing computer readable instructions; and a processor on the platform connected to the memory and the multi-touch surface; said computer readable instructions configured, upon processing by said processor, to cause the device to: define a key pad at each of five locations on the multi-touch surface, wherein: each pad comprises a plurality of touch sensitive keys; and each touch sensitive key is assigned to a character or a function; a first pad is sensitive to a range of user actions that cause the processor to register characters A, B, C, D and E depending on the action; a second pad is sensitive to a range of user actions that cause the processor to register characters F, G, H, I and J depending on the action; a third pad is sensitive to a range of user actions that cause the processor to register characters K, L, M, N and O depending on the action; a fourth pad is sensitive to a range of user actions that cause the processor to register characters P, Q, R, S, and T depending on the action; a fifth pad is sensitive to a range of user actions that cause the processor to register characters U, V, W, X and Y depending on the action; detect activation of a touch sensitive key; and register in memory the character or function corresponding to the touch sensitive key activated.

### BRIEF DESCRIPTION OF DRAWINGS

The drawings illustrate embodiments of the invention, which should not be construed as restricting the scope of the invention in any way.

FIG. 1 is a schematic side cutaway view of an electronic device with an exemplary embodiment of a multi-touch surface in accordance with the present invention.

FIG. 2 is a user's view of an exemplary embodiment of a single-hand keyboard layout on the multi-touch surface of the electronic device of FIG. 1 in relation to a user's hand.

FIG. 3 is a diagram of an alternative embodiment of a single-hand keyboard for entering text.

FIG. 4 is a diagram of the embodiment of FIG. 3 after toggling to a single-hand keyboard layout for entering numbers.

FIG. 5 is a flowchart for toggling between the display of letter characters and the display of numerical digits.

FIG. 6 is a diagram demonstrating user input finger strokes relative to the keyboard layout of FIG. 2.

FIGS. 7-10 show diagrams of alternate character entry pad layouts.

FIG. 11 shows a flowchart for calibrating the single-hand keyboard.

FIG. 12 is a flowchart for determining the mode of operation of the single-hand keyboard.

FIG. 13 is a flowchart for personalizing the character assignments of the single-hand keyboard.

FIG. 14 is a layout of the letters of the single-hand keyboard for a smart phone

FIG. 15 is a layout of the digits of the single-hand keyboard for a smart phone

### DESCRIPTION

Throughout the following detailed description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

The description is also presented in terms of methods or processes, symbolic representations of operations, functionalities and features of the invention. These method descriptions and representations are the means used by those skilled in the art to most effectively convey the substance of their work to others skilled in the art. A software implemented method or process is here, and generally, conceived to be a self-consistent sequence of steps leading to a desired result. These steps require physical manipulations of physical quantities. Often, but not necessarily, these quantities take the form of electrical or magnetic signals or values capable of being stored, transferred, combined, compared, and otherwise manipulated. It will be further appreciated that the line between hardware and software is not always sharp, it being understood by those skilled in the art that software implemented processes may be embodied in hardware, firmware, or software, in the form of coded instructions such as in microcode and/or in stored programming instructions.

Definitions of some terms used in this disclosure:

Multi-touch surface—Relating to computing and electronic devices, this is a touch sensitive surface that can detect the presence of one, two or more points of contact on its surface, such as a user's fingertips. Points of contact could also be finger nails, gloved fingers or styli depending on the technology of the multi-touch screen. There is not necessarily a display on such a surface or provided behind or through such a surface, but characters and/or keys may be printed on or embedded in such a surface.

Multi-touch screen—A multi-touch screen refers to a display with a multi-touch surface. A multi-touch screen has the ability to recognize the presence of one, two or more points of contact on its surface. In most cases these points will be a user's fingers but could also be finger nails, gloved fingers or styli depending on the technology of the multi-touch screen. There are several types of multi-touch screen technology appropriate for use with the invention, including, for example, capacitive, infra-red, optical imaging and dispersive signal.

Multi-touch plate—A multi-touch surface without a display.

Fingers—When used herein, this term may include a user's thumb as well as the user's other digits. Likewise, a fingertip may be taken to mean a tip of a thumb as well as a tip of a finger.

Character—A letter, number, symbol, punctuation mark or function (such as ‘Enter’, ‘Delete’, etc). A character is registered by a processor in the electronic device after a user has applied one or more tapping or sweeping actions with the multi-touch screen interface.

Key—A key is a portion of the multi-touch screen to be tapped and/or swept in order for a user to cause the processor of the electronic device to register a character. Each key is assigned a default character, but the user can modify any default character or assign an alternative keypad or keyboard layouts.

Pad, Key Pad or Finger Pad—Generally refers to an area of the multi-touch screen or multi-touch surface allocated with a particular set of keys and intended to be used by a single finger. A pad may be identified by the finger with which it is intended to be used, i.e., thumb pad.

Simultaneous tapping—Refers to tapping two or more fingers together on the multi-touch screen. In practice, the fingers will not actually be tapped simultaneously, and so simultaneous tapping is meant to cover cases where the fingers are tapped sufficiently close in time to each other that they can be interpreted as being tapped together. A time difference between two such taps would be significantly less than the time difference between the same two fingers being intentionally tapped individually for the purpose of registering two separate characters.

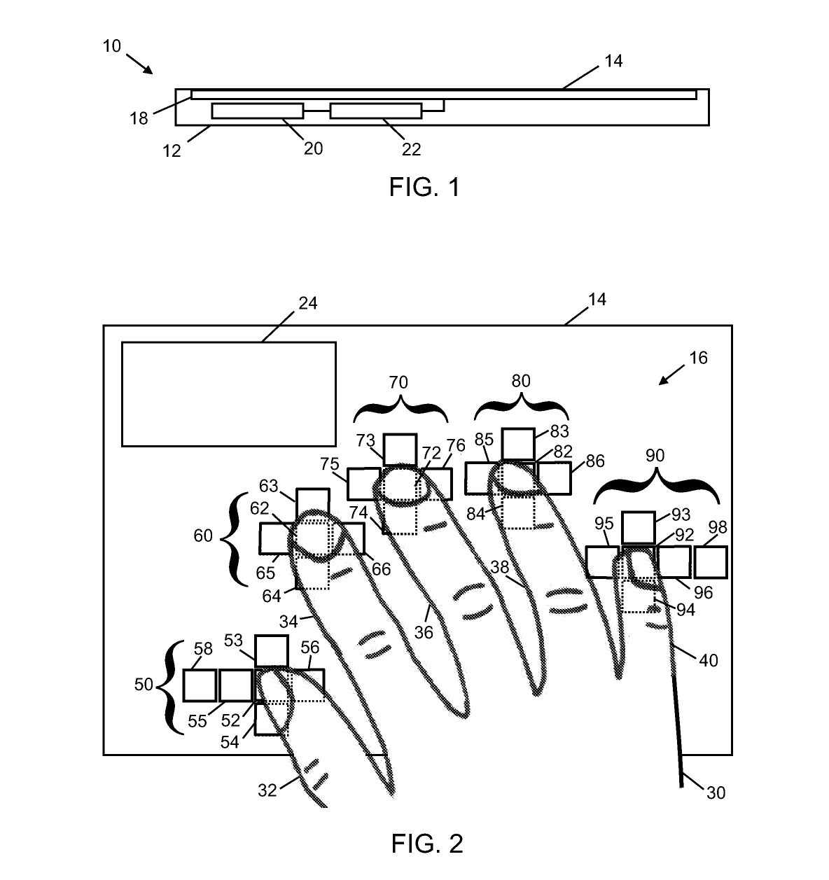

Referring to FIG. 1, an exemplary embodiment of an electronic device 10 is shown that includes a platform 12 having a multi-touch surface 14 thereon configured with a single-hand keyboard 16, as seen in FIG. 2. The platform 12 may also include a multi-touch screen 18 having the multi-touch surface 14. The electronic device 10 also includes a memory 20 and one or more processors 22 connected to the memory 20 and to the multi-touch surface 14. Computer readable instructions are stored in the memory 20 and processed by the processor(s) 22 in order to control the multi-touch surface 14 and if necessary the output of the multi-touch screen 18. The processor(s) 22, by reading the computer readable instructions, are also responsible for interpreting any finger touch inputs received at the keyboard 16 of the multi-touch surface 14 of the multi-touch screen 18. The memory 20 may in part or in whole be located within the processor(s) 22. Examples of electronic devices 10 that can be configured for the single hand, multi-touch screen keyboard 16 include the iPad™ and other similar tablet computing devices. Peripheral multi-touch screens 18 that plug into desktops and laptops may also be included. Program coding for the single-hand keyboard 16 may be achieved using known programming languages.

Referring to FIG. 2, an example of the single-hand keyboard 16 is shown. A user's right hand 30 is shown in a relaxed position over a multi-touch surface 14 of the multi-touch screen 18. The user's fingers are slightly curved and the fingertips are not touching the surface 14 of the screen 18. The user's wrist may rest on a surface on which the screen 18 is supported or it may hover without support. The screen 18 optionally includes an area for character display 24 showing input by the user. At separate locations on the multi-surface surface 14, the keyboard 16 displayed by the multi-touch surface includes multiple, preferably five, key pads, namely a thumb pad 50, index finger pad 60, middle finger pad 70, ring finger pad 80, and little finger pad 90. The center of each pad (50, 60, 70, 80, 90) is respectively aligned with a contacting tip of the user's fingers, namely thumb 32, index finger 34, middle finger 36, ring finger 38, and little finger 40. Depending on the position of the user's hand and the orientation of each finger, the portion of the tip contacting the multi-touch surface 14 may be at or around the middle of the tip or near its side.

Each finger's assigned key pad (50, 60, 70, 80, 90) of the keyboard 16 includes multiple, typically five, keys, although in this example both the thumb pad 50 and the little finger pad 90 have an extra non-central key 58 and 98, respectively. Each of the key pads (50, 60, 70, 80, 90) includes a respective single, central key (52, 62, 72, 82, 92) and respective multiple, non-central keys (53-56, 63-66, 73-76, 83-86, 93-96) together with the extra non-central keys 58 and 98. Each non-central key in a pad may be activated by a tap or a swipe, resulting in the registration by the processor of a character.

Referring to the thumb pad 50, it includes six keys (52-56, 58), where the central key 52 is activated when the thumb 32 taps in its rest position. Upper key 53 is activated when the thumb 32 taps on the thumb pad 50 at a location a little way above its rest position. Lower key 54 is activated when the thumb 32 taps on the thumb pad 50 a little way below its rest position. Left key 55 is activated when the thumb 32 taps on the thumb pad 50 a little way to the left of its rest position. Right key 56 is activated when the thumb 32 taps on the thumb pad 50 a little way to the right of its rest position. Far left key 58 is activated when the thumb 32 taps on the thumb pad 50 a little way to the left of the left key 55. Keys 52, 53, 54, 55, 56, 58 may be contiguous or they may be separated by a gap which does not respond with the processor 22 registering a character. The shapes of the keys may be other than square or rectangular, rhomboid, and may be regular, irregular elliptical or curved.

Referring to the index finger pad 60, it includes five keys (62-66), where the central key 62 is activated when the index finger 34 taps in its rest position. Upper key 63 is activated when the index finger 34 taps on the index finger pad 60 at a location a little way above its rest position. Lower key 64 is activated when the index finger 34 taps on the index finger pad 60 a little way below its rest position. Left key 65 is activated when the index finger 34 taps on the index finger pad 60 a little way to the left of its rest position. Right key 66 is activated when the index finger 34 taps on the index finger pad 60 a little way to the right of its rest position.

Referring to the middle finger pad 70, it includes five keys (72-76), where the central key 72 is activated when the middle finger 36 taps in its rest position. Upper key 73 is activated when the middle finger 36 taps on the middle finger pad 70 at a location a little way above its rest position. Lower key 74 is activated when the middle finger 36 taps on the middle finger pad 70 a little way below its rest position. Left key 75 is activated when the middle finger 36 taps on the middle finger pad 70 a little way to the left of its rest position. Right key 76 is activated when the middle finger 36 taps on the middle finger pad 70 a little way to the right of its rest position.

Referring to the ring finger pad 80, it includes five keys (82-86), where the central key 82 is activated when the ring finger 38 taps in its rest position. Upper key 83 is activated when the ring finger 38 taps on the ring finger pad 80 at a location a little way above its rest position. Lower key 84 is activated when the ring finger 38 taps on the ring finger pad 80 a little way below its rest position. Left key 85 is activated when the ring finger 38 taps on the ring finger pad 80 a little way to the left of its rest position. Right key 86 is activated when the ring finger 38 taps on the ring finger pad 80 a little way to the right of its rest position.

Referring to the little finger pad 90, it includes six keys (92-96, 98), where the central key 92 is activated when the little finger 40 taps in its rest position. Upper key 93 is activated when the little finger 40 taps on the little finger pad 90 at a location a little way above its rest position. Lower key 94 is activated when the little finger 40 taps on the little finger pad 90 a little way below its rest position. Left key 95 is activated when the little finger 40 taps on the little finger pad 90 a little way to the left of its rest position. Right key 96 is activated when the little finger 40 taps on the little finger pad 90 a little way to the right of its rest position. Far right key 98 is activated when the little finger 40 taps on the little finger pad 90 a little way to the right of the right key 96.

Positions of the key pads (50, 60, 70, 80, 90) of the keyboard 16 on the multi-touch screen 18 may be different to those shown, depending on the orientation, shape and size of the user's hand. For example, the user may angle the multi-touch screen 18 in the same way as one often angles writing paper when writing, and this would result in the key pads being positioned generally closer to the lower edge of the multi-touch screen 18.

Each individual finger key pad (50, 60, 70, 80, 90) extends from a central position to a perimeter of its respective location on the multi-touch surface 14 that can be reached by the corresponding fingertip without bodily displacement of the hand. For example, the pads can be covered by the fingertips without lifting the wrist if it is supported. The pads are not large enough to overlap, although in some embodiments overlap may be allowed if the keyboard 16 is configured to discern which finger is moving or causing the action. Furthermore, it is intended that while the user may need to bend or extend the fingers, or move them sideways, undue stretching of the fingers is not necessary.

The character display 24 may be shaped, positioned or angled differently, according to the user's preferences or to the particular application the user is using. The optional character display 24 may not appear on the multi-touch screen 18, such as when the single-hand keyboard 16 is used as a peripheral multi-touch screen connected to a desktop or other computer having a monitor that can display the entered text. This may also happen when the device 10 is embodied in a multi-touch plate that is connected as a peripheral to another computing device. Where a multi-touch plate is used, the keys will not be displayed on it, although it is possible to print on the plate or another surface of the device an indication as to which keys correspond to which characters, without necessarily locating the indications at actual positions of the keys since these are intended to change to suit each user. For example, a key chart may be printed across an upper edge of the multi-touch plate. In other embodiments, the keys may be displayed on a monitor of a computing device to which the multi-touch plate is connected.

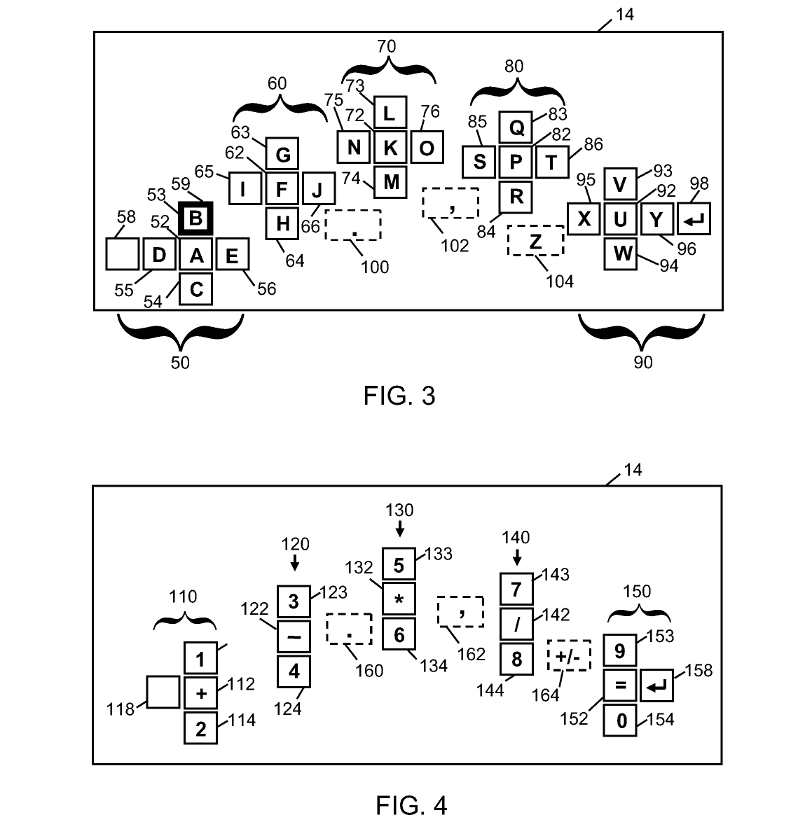

FIG. 3 shows an alternative embodiment of the multi-touch surface 14 with an assignment of characters to the key pads (50, 60, 70, 80, 90) of the single-hand keyboard. Letters of the alphabet are displayed on the surface 14 to help users locate the keys.

The thumb pad 50 comprises the first five letters of the alphabet and the space key. Central key 52 is assigned to ‘A’, upper key 53 is assigned to ‘B’, lower key 54 is assigned to ‘C’, left key 55 is assigned to D′ and right key 56 is assigned to ‘E’. The far left key 58 is assigned to ‘Space’. The key “B” 53 is shown to be lit up by a brighter border and increase in font size, due to it just having been tapped by a user. Such visual feedback may be provided, transiently, by each key that is tapped, to indicate to a user that the corresponding character has been registered by the keyboard. Visual feedback may be provided in many different forms, including a color change, a font change, a font size change, a brightness change etc. Audible feedback may also or instead be provided.

The index finger pad 60 comprises the next five letters of the alphabet. Central key 62 is assigned to ‘F’, upper key 63 is assigned to ‘G’, lower key 64 is assigned to ‘H’, left key 65 is assigned to ‘I’ and right key 66 is assigned to ‘J’.

The middle finger pad 70 comprises the following five letters of the alphabet. Central key 72 is assigned to ‘K’, upper key 73 is assigned to ‘L’, lower key 74 is assigned to ‘M’, left key 75 is assigned to ‘N’ and right key 76 is assigned to ‘O’.

The ring finger pad 80 comprises the following five letters of the alphabet. Central key 82 is assigned to ‘P’, upper key 83 is assigned to ‘Q’, lower key 84 is assigned to ‘R’, left key 85 is assigned to ‘S’ and right key 86 is assigned to ‘T’.

The little finger pad 90 comprises the next five letters of the alphabet and the enter key. Central key 92 is assigned to ‘U’, upper key 93 is assigned to ‘V’, lower key 94 is assigned to ‘W’, left key 95 is assigned to ‘X’ and right key 96 is assigned to ‘Y’. The far right key 98 is assigned to ‘Enter’.

Indicator areas 100, 102, 104 are used to signal to the user that a specific character may be registered by tapping with the two fingers either side of it, or that a specific character has been activated. Indicator areas 100, 102, 104 can be located in different positions, such as above the pads rather than below them. Each area indicates the character that results from tapping two fingers at a time. Period indicator 100 is displayed between the index finger pad 60 and the middle finger pad 70, and the single-hand keyboard will register a period when the index 34 and middle 36 fingers are tapped simultaneously. The index 34 and middle 36 fingers may be tapped in their rest positions, over the central keys in their respective pads or they may be tapped anywhere in the respective pads depending on the particular implementation chosen. The same method would apply for other actions requiring two fingers to be tapped.

Comma indicator 102 is located between the middle finger pad 70 and the ring finger pad 80 and displays a comma when the middle 36 and ring 38 fingers are tapped simultaneously. “Z” indicator 104 is located between the ring finger pad 80 and the little finger pad 90, and displays a ‘Z’ when the ring 38 and little 40 fingers are tapped simultaneously. Alternately, or instead, the indicator areas 100, 102, 104 may also act as auxiliary keys, and may be activated by either one or two fingers.

When operating any one of the keys on the single-hand keyboard 16, a character may be repeated by keeping the finger touching the key, in a similar way to conventional keyboards.

In the present embodiment of the keyboard layout, all of the numbers and letters of the alphabet can be entered individually except for the letter “Z”. The letter “Z” and all other function keys or symbols can be entered with the same technique, but using combinations of two or more fingers.

TABLE 1 shows examples of how various further functions may be enabled by the tapping or sweeping of multiple fingers. There may be a default mode in which all these functions are pre-assigned to the finger actions. Some of them may be customizable and some non-customizable. Some may be initially unassigned so that the user can define them. Different single-hand keyboards may be used depending on the application requiring input. For example, different layouts and even different symbols or functions may be used for accounting applications, spreadsheets, shorthand typing applications, programmers, stock traders, scientists, engineers, etc.

TABLE 1
Key Pad Entry Options

| Function | Fingers | Action |
|---|---|---|
| One capital letter | 3 or 4 | Tap once |
| Capital lock on | 3 or 4 | Tap twice |
| Capital lock off | 3 or 4 | Tap thrice |
| One number | Thumb and little | Tap once |
| Number lock on | Thumb and little | Tap twice |
| Number lock off | Thumb and little | Tap thrice |
| Backspace | 3 or 4 | Sweep left |
| Delete | 3 or 4 | Sweep right |
| Scroll up | 3 or 4 | Sweep up |
| Scroll down | 3 or 4 | Sweep down |
| Move left (←) | Index and middle | Sweep left |
| Move right (→) | Index and middle | Sweep right |
| Move up (↑) | Index and middle | Sweep up |
| Move down (↓) | Index and middle | Sweep down |
| @ | Middle and ring | Sweep left |
| Underscore (_) | Middle and ring | Sweep right |
| Quote (“) | Middle and ring | Sweep up |
| Apostrophe (') | Middle and ring | Sweep down |
| Question mark (?) | Ring and little | Sweep left |
| Exclamation mark (!) | Ring and little | Sweep right |
| Dollar sign ($) | Ring and little | Sweep up |
| Number sign (#) | Ring and little | Sweep down |

Where some functions have been specified that require the same action irrespective of whether three or four fingers are used, it is possible in other embodiments to define one set of functions that require three fingers and a different set of functions that require four fingers. Furthermore, particular fingers may be specified, as has been done for the two-finger actions. For example, one capital letter may be specified by the use of thumb, index and middle finger.

Referring to FIG. 4, another view of the embodiment of the multi-touch surface 14 described in FIG. 3 is shown, after the display has been toggled from displaying the alphabetical key pads to displaying number key pads. Thumb 32 and little finger 40 are tapped once or twice to toggle to the number key pad display, in order to either register a single digit or to switch on the number lock, respectively. In FIG. 4, the multi-touch surface 14 displays five number key pads of the keyboard, namely a thumb number pad 110, index finger number pad 120, middle finger number pad 130, ring finger number pad 140, and little finger number pad 150. Note that the center keys (112, 122, 132, 142, 152) of each of the number key pads are in the same location as the corresponding center keys (52, 62, 72, 82, 92) of the alphabetical key pads.

The thumb number pad 110 is used by the thumb 32, the index finger number pad 120 by the index finger 34, etc. The central key 112 of the thumb number pad 110 is assigned to a plus sign, upper key 113 is assigned to digit ‘1’, lower key 114 is assigned to digit ‘2’, and left key 118 is assigned to ‘space’. To conform to the alphabetic display of the single hand keyboard, the numerical space key may be extended to the left or positioned to the left of where it is shown in the diagram.

The index number pad 120 is for activation by the index finger 34. The central key 122 is assigned to the minus sign, upper key 123 is assigned to digit ‘3’ and lower key 124 is assigned to digit ‘4’. The middle finger number pad 130 is for activation by the middle finger 36. The central key 132 is assigned to the multiplication sign, upper key 133 is assigned to digit ‘5’ and lower key 134 is assigned to digit ‘6’. The ring finger number pad 140 is for activation by the ring finger 38. The central key 142 is assigned to the division sign, upper key 143 is assigned to digit ‘7’ and lower key 144 is assigned to digit ‘8’. The little finger number pad 150 is for activation by the little finger 40. The central key 152 is assigned to the equal sign, upper key 153 is assigned to digit ‘9’, lower key 154 is assigned to digit ‘0’, and right key 158 is assigned to the function ‘enter’. Similar to the text entry implementation shown in FIG. 3, indicator areas may signal to the user that a specific character has been activated, namely period indicator 160, comma indicator 162, and the “+/−” indicator 164. As in the text implementation, indicator areas may also be used as auxiliary keys.

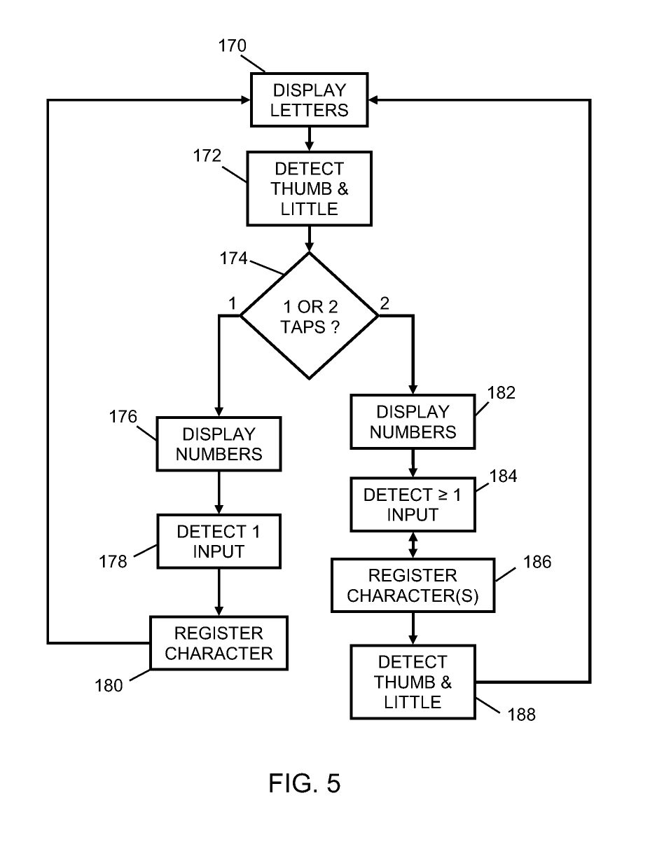

Referring to FIG. 5, a flowchart is shown of how the electronic device 10 with keyboard 16 toggles from displaying the alphabet keys to the number keys. In step 170, the keys of the alphabet are displayed (as in FIG. 3) and during this step the processor 22 can register none, one or multiple letters. The processor 22 in step 172 then detects that the multi-touch surface 14 has been tapped with a user's thumb and little finger together. The processor then determines in step 174 whether or not a second tap of the user's thumb and little finger together has been received. If only one tap is received, then this is interpreted by the processor as an instruction to display in step 176 the digital keys (FIG. 4) until activation of a single key of the number key pads has been detected. The multi-touch surface 14 detects the single input in step 178, which is registered as a character by the processor 22 in step 180, following which the processor causes the display to toggle back to the alphabetic display as in step 170.

If in step 174 the processor 22 detects a second tap of the thumb and little finger together, the two taps are interpreted by the processor as a function that causes the number lock to be switched on. This causes the indefinite display of the number keys in step 182. The multi-touch surface 14 can then accept none, one or more number key inputs in step 184, the processor 22 registering each input in step 186. Note that the process actually cycles back and forth between steps 184 and 186. When the multi-touch surface 14 detects in step 188 one or more simultaneous taps of the thumb and little finger, the processor causes the display to revert back to the alphabetical keyboard mode, as in step 170.

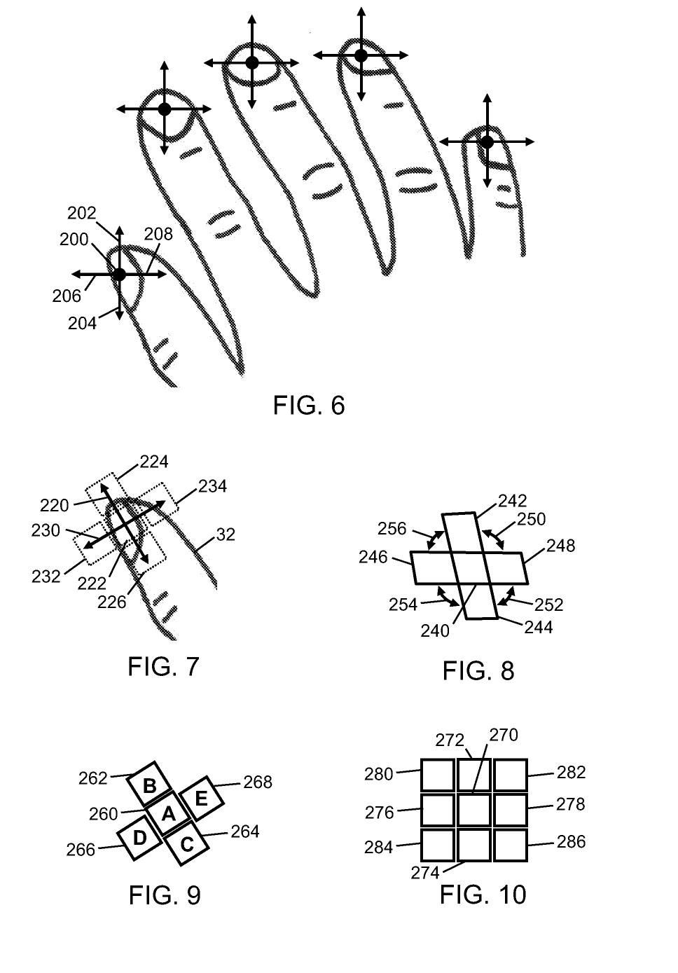

FIG. 6 demonstrates the different finger sweep directions to which key pad may respond. For example, the thumb pad 50 may be responsive to thumb 32 movement, when in contact with the surface 20 of the screen 12, with a brief up sweep 202 and then returning to its rest position 200. It may also be responsive to the thumb 32 down sweeping 204 then back to rest 200, left sweep 206 then back to rest and right sweep 208 then back to rest. The single-hand keyboard may also be responsive to similar motions input by the user's other fingers. Each cycle of a sweep and return to the rest position may activate a key in order to register a character or invoke a function. The layout of the keys and the functions and characters to which they are assigned may be the same as shown in FIGS. 3 and 4, allowing the user to use two different operational modes. For example, in a standard mode, the user's hand may hover above the single-hand keyboard, the user's fingers making contact with the keyboard only when activating keys through taps or sweeps. In a lazy mode, the user's fingers rest on the board and keys are registered by directional sweeps of individual or multiple fingers. Instead of sweeps, the user may lift a finger and put it down to register the same key as a tap. This would be the case for keys located at the rest position of the finger tips and for multiple-finger taps. For registering keys that are off center, the user may sweep towards that key, then lift and return to the center key, or rest position. Alternately, the user may lift a finger from the rest position and land on an off-center key to register it, and then let the finger sweep back to the rest position.

More advanced error correction subroutines are contemplated as necessary to compensate for the more significant twitches of other fingers when registering keys in the lazy mode. This mode is more difficult to use than the standard mode because it is possible to accidentally move a finger and unintentionally register a different key. A user when proficient at operating the single hand keyboard in the lazy mode will look like his fingers are making tiny twitches. Significantly less physical effort is required for this mode once a certain level of proficiency has been attained.

Referring to FIG. 7, the natural or most comfortable directions of motion of the fingers will in general not all be orthogonal, nor aligned with the sides of the multi-touch screen, particularly if the user is not attentive to aligning the single-hand keyboard in any particular way. For example, the most comfortable directions of motion may be diagonal compared to the orientation of the screen, such as a diagonal up sweep 220, or diagonal left sweep 230. FIG. 7 shows the thumb 32 in rest position over diagonal central key 222. Diagonal upper key 224 is reached by the user moving his thumb 32 up and to the left, or effectively extending it. Diagonal lower key 226 is reached by the user moving his thumb 32 down and to the right, or retracting it. The thumb 32 is moved along a diagonal left sweep 230 to reach left key 232 and right key 234. All or some the pads may be arranged in this way depending on the user, which each pad possibly being aligned at a different angle with respect to the sides of the multi-touch screen.

FIG. 8 shows an example of a key pad in which the keys are neither square nor rectangular, but rhomboid, i.e. a parallelogram in which adjacent sides are of unequal lengths and angles are oblique. Rhomboid central key 240, rhomboid upper key 242 and rhomboid lower key 244 are arranged in a diagonal line relative to the sides of the screen. Rhomboid left key 246, rhomboid central key 240 and rhomboid right key 248 are aligned parallel to the top and bottom edges of the screen. In other embodiments, some or all of the angles 250, 252, 254, 256 may be different depending on the user, the embodiment, the type of screen, the application, etc.

FIG. 9 shows another example of a key pad, in which keys ‘A’ 260, ‘B’ 262 and ‘C’ 264 are in a line, but keys ‘D’ 266′, ‘A’ 260 and ‘E’ 268 are positioned along an arc.

FIG. 10 shows a more populated finger key pad in which there are nine keys. The central key 270, upper key 272, lower key 274, left key 276 and right key 278 of the pads described above are complemented with four additional keys 280, 282, 284, 286. This embodiment may be used if the multi-touch screen is too small to efficiently accommodate five key pads, or if the user has one or more missing or injured fingers.

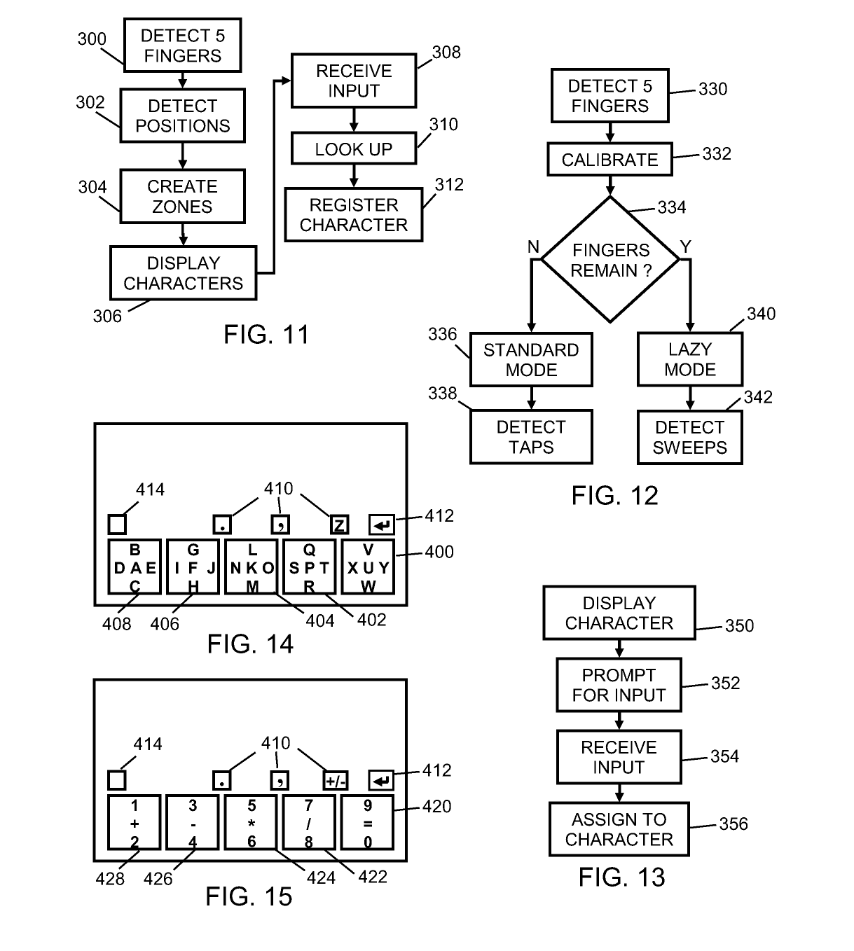

FIG. 11 shows a process by which an electronic device 10 performs when configured as a single-hand keyboard. In step 300, the multi-touch screen detects contact with five fingers and the processor determines the positions of contact of the five fingers in step 302. The processor, in step 304, creates zones of five pads each centered on one of the positions of contact previously detected. The processor then causes the multi-touch screen to display at the locations of the pads, in step 306, the characters for each of the keys in the five pads. In step 308, the screen then monitors for contact and receives an input from the user, such as a tap or a sweep. The processor determines where on the screen the input occurred and in step 310 looks up in memory the character or function to which the key is assigned. The processor then registers the looked up character in step 312, which may include displaying the character in a text entry field on the touch screen.

At any point, if the single-hand keyboard detects the contact of five fingers; it may jump to step 300 to recalibrate the system. The display of the keys may therefore automatically adjust, resulting in a changed display position whenever the system re-calibrates the resting position of the fingers.

In step 308, when the screen is in ‘listening’ mode and receives an input, the processor is configured to allow for a fraction of a second wait in anticipation of other fingers possibly touching the keyboard. If other fingers came in contact with the keyboard within this fraction of a second, then the action will be registered as a combo key. The exact amount of time may be set by default, it may be learnt by monitoring an analyzing corrections made by a user, or it may be set by requesting the user to enter some test multiple-finger taps and then taking the longest period between first and last contacts. Other methods for determining the time wait may also be used.

Calibration may continue for each finger sweep during a set period of use, or on an ongoing basis. To increase directional sweep accuracy, a set number of directional sweeps may be recorded and the keyboard may be calibrated according to the median directional angles of each finger sweep. Equally, when tapping, a running average position of taps for a given key may be continually monitored, and the display location and response area of that key may be dynamically adjusted as required.

As part of the calibration process, the single-hand keyboard may be configured to detect whether a left hand or a right hand is using the keyboard, and it may configure the keys differently as a result, although this may not be necessary.

FIG. 12 shows a flowchart of a process used by the processor to determine which mode the user is operating the screen in, if it is not set by default or selected by the user. In step 330, the presence of five fingers in contact with the screen is detected. In step 332, the keyboard is calibrated as before, to determine the positions of the key pads. In step 334, the process determines whether or not the five fingers remain in contact with the screen. If they do not remain, the keyboard operates in standard mode 336, and detects taps 338 and/or sweeps that start and finish with the finger out of contact. If in step 334 the fingers are detected to remain in contact with the screen, the keyboard operates in lazy mode 340, and goes on to detect sweeps 342 that are preceded and/or followed by the finger resting on the screen.

FIG. 13 shows a process in which the single-hand keyboard may be customized. For example, in step 350, the keyboard may display a character, and prompt for an input that corresponds to that character in step 352. Following the receipt in step 354 of an input from the user, the processor then assigns the received input to the displayed character in step 356, storing the relation in memory.

Depending on the embodiment implemented, some or all of the keys and some or all of the required actions to register them may be displayed on the single-hand keyboard.

Once a key is registered, the corresponding key may momentarily light up or change color. In other embodiment, an audible click may be emitted. Subtle sweeping motion trails may be transiently displayed as feedback to show the user that sweeping actions have been recognized.

Smart phones may be configured with a single-hand keyboard, although modification may be needed if the multi-touch screen is too small. Such modification may include the use of fewer fingers and more keys per finger in order to cover the whole alphabet.

FIG. 14 shows an example of a layout of the single-hand keyboard for a smaller multi-touch screen, as may be found in a smart phone, for example. The key pads 400, 402, 404, 406, 408 are each for use with a single fingertip, but either a single fingertip may be used for all five pads or one or more different fingertips may be used for each depending on the preference of the user. A key in a key pad is activated depending on its position in the key pad. The central letters A, F, K, P and U are each activated by the user applying a single tap to the respective key pad. The upper letters B, G, L, Q and V are activated by the user swiping the respective key pad in an upwards direction. The lower letters C, H, M, R and W are activated by the user swiping downwards in the respective key pad. The left hand letters D, I, N, S and X are activated by the user swiping to the left in the respective key pad. The right hand letters E, J, O, T and Y are activated by the user swiping to the right in the respective key pad. The Z is activated by the user tapping simultaneously in the two rightmost key pads 400, 402. The comma is activated by the user tapping simultaneously in the two rightmost key pads 402, 404. The period is activated by the user tapping simultaneously in the two rightmost key pads 404, 406. The return key is activated by the user tapping in the key pad 412. The space is activated by the user tapping in the key pad 414. In other embodiments, key pads 412 and 414 may be positioned as strips or further keys to the right and left of the main key pads 400, 402, 404, 406, 408. Display areas 410 may be used to inform the user which pairs of key pads need to be tapped together to active the character displayed in the respective display area. In other embodiments, such display areas 410 may also be used as keys that can be tapped to activate the respective character.

FIG. 15 shows an example of a layout of the digits in a single-hand keyboard for a smaller multi-touch screen. The key pads 420, 422, 424, 426, 428 are each for use with a single fingertip, but either a single fingertip may be used for all five pads or one or more different fingertips may be used for each depending on the preference of the user. The central characters plus, minus, multiply, divide and equal are each activated by the user applying a single tap to the respective key pad. The upper digits 1, 3, 5, 7 and 9 are activated by the user swiping the respective key pad in an upwards direction. The lower digits 2, 4, 6, 8, and 0 are activated by the user swiping downwards in the respective key pad. The +/− key is activated by the user tapping simultaneously in the two rightmost key pads 420, 422.

As yet a further embodiment, six key pads may be used on a smaller touch-screen. Many users find it natural to use two thumbs when typing on a mobile device, and so there could be three pads for each thumb. Five of the pads could be used for the first 25 letters of the alphabet and the sixth pad could be used for the most frequently used functions such as space, return, delete, backspace and number lock. The sixth pad may also be configurable by the user, and may be configured to include the letter Z, for example. Contact of two thumbs at a time may be used to register further characters or functions, and multiple taps of the two thumbs could also trigger further characters.

Keys of conventional QWERTY keyboards are arranged to slow users down, which is an inheritance from the early days of mechanical typewriters. The keys of the AFKPU are arranged according to the alphabet, which may be easier to learn. Other key arrangements are also possible, such as an approximate mapping of the QWERTY layout, which may help convert existing QWERTY users to the one-handed keyboard. Different keyboard layout may be used such as DVORAK, or according to national customs and different types of alphabet, such as need for Greek and Russian. Alternately, an assignment of the most frequently used keys to the stronger fingers of the hand may be used. People who have one or more injured or amputated fingers may use a keyboard layout that requires fewer fingers.

To summarize industrial applicability, the advantages of the invention may include one or more of the following: single hand use; can be used by left-handed or right-handed people; minimal physical effort is necessary to register a character; less hand strain than for a conventional keyboard; reduced carpal tunnel syndrome; less desk space needed compared to a conventional keyboard; no peripheral keyboard attachment is needed for devices such as notebooks, tablet computers or cell phones; it eliminates the need to have a dedicated keyboard area for notebooks; it may be easier for newcomers to learn an AFKPU keyboard than a QWERTY one because the keys are arranged alphabetically; key positions and keyboard layout can be customized easily to fit different individuals or an individual's different tasks; and it is easy to implement into currently available electronic devices such as tablet computers.

As will be apparent to those skilled in the art in the light of the foregoing disclosure, many alterations and modifications are possible in the practice of this invention without departing from the scope thereof. Accordingly, the scope of the invention is to be construed in accordance with the substance defined by the following claims.

1. An electronic device, comprising:
a platform having a multi-touch surface configured with a single-hand keyboard;
a memory on the platform storing computer readable instructions; and
a processor on the platform connected to the memory and the multi-touch surface;
said computer readable instructions configured, upon processing by said processor, to cause the device to:
define a pad at each of two or more locations on the multi-touch surface, wherein:
each location corresponds to a different fingertip of a single hand;
each of the pads comprises a plurality of touch sensitive keys; and
each of the touch sensitive keys is assigned to a character or a function;
detect activation of a selected one of the touch sensitive keys; and
register in memory the character or function corresponding to the selected one of the touch sensitive keys activated.

2. The electronic device of claim 1 in which the platform includes a multi-touch screen having the multi-touch surface.

3. The electronic device of claim 1 in which there are five of the pads and five or six of the touch sensitive keys in each of the pads.

4. The electronic device of claim 3 in which the keys of each of the pads include a central one of the keys aligned with a rest position of the corresponding fingertip.

5. The electronic device of claim 4 in which the central keys of the pads are each assigned with a different one of letters A, F, K, P and U.

6. The electronic device of claim 5 in which:
the keys of a first one of the pads are assigned respectively to letters A, B, C, D and E and ‘Space’ function;
the keys of a second one of the pads are assigned respectively to letters F, G, H, I and J;
the keys of a third one of the pads are assigned respectively to letters K, L, M, N and O;
the keys of a fourth one of the pads are assigned respectively to letters P, Q, R, S and T; and
the keys of a fifth one of the pads are assigned respectively to letters U, V, W, X and Y and ‘Enter’ function.

7. The electronic device of claim 5 in which the keys may be toggled with another set of touch sensitive keys assigned with digits.

8. The electronic device of claim 1 in which each pad extends from a central position to a perimeter of the location of the pad on the multi-touch surface that can be reached by the corresponding fingertip without bodily displacement of the hand.

9. The electronic device of claim 1 wherein activation of each of the touch sensitive keys is by a tap, a sweep thereto, a sweep therefrom, a sweep thereto and therefrom, a lift, or a lift and replace.

10. The electronic device of claim 1 further configured to provide visual feedback that a touch sensitive key has been activated.

11. The electronic device of claim 2 further configured to display, on the multi-touch screen, characters or functions assigned to multi-finger actions.

12. The electronic device of claim 2 further configured, prior to defining the pads, to determine locations on the multi-touch screen of two or more concurrent touches each corresponding to a different fingertip of a single hand.

13. The electronic device of claim 12 configured to determine locations on the multi-touch screen of five concurrent touches each corresponding to a different fingertip of the hand.

14. The electronic device of claim 13 configured to:
re-determine locations on the multi-touch screen of five concurrent touches each corresponding to the fingertips of the hand; and
reposition the pads at each of said re-determined locations.

15. A method for receiving inputs via an electronic device with a multi-touch surface configured with a single-hand keyboard connected to a processor, the processor, when acting upon computer readable instructions stored in a memory connected to the processor, causing the electronic device to perform the steps of:
defining a pad at each of two or more locations on the multi-touch surface, wherein:
each location corresponds to a different fingertip of a single hand;
each of the pads comprises a plurality of touch sensitive keys; and
each of the touch sensitive keys is assigned to a character or a function;
detecting activation of a selected one of the touch sensitive keys; and
registering in memory the character or function corresponding to the selected one of the touch sensitive key activated.

16. The method of claim 15 in which there are five of the pads and five or six of the touch sensitive keys in each of the pads.

17. The method of claim 16 in which:
the keys of a first one of the pads are assigned respectively to letters A, B, C, D and E and ‘Space’ function;
the keys of a second one of the pads are assigned respectively to letters F, G, H, I and J;
the keys of a third one of the pads are assigned respectively to letters K, L, M, N and O;
the keys of a fourth one of the pads are assigned respectively to letters P, Q, R, S and T; and
the keys of a fifth one of the pads are assigned respectively to letters U, V, W, X and Y and ‘Enter’ function.

18. The method of claim 15 in which the keys may be toggled with another set of touch sensitive keys assigned with digits.

19. The method of claim 15 in which each pad extends from a central position to a perimeter of the location of the pad on the multi-touch surface that can be reached by the corresponding fingertip without bodily displacement of the hand.

20. An electronic device, comprising:
A platform having a multi-touch surface configured with a keyboard;
a memory on the platform storing computer readable instructions; and
a processor on the platform connected to the memory and the multi-touch surface;
said computer readable instructions configured, upon processing by said processor, to cause the device to:
define a pad at each of five locations on the multi-touch surface, wherein:
each of the pads comprises a plurality of touch sensitive keys; and
each of the touch sensitive keys is assigned to a character or a function;
a first one of the pads is sensitive to a range of user actions that cause the processor to register characters A, B, C, D and E depending on the action;
a second one of the pads is sensitive to a range of user actions that cause the processor to register characters F, G, H, I and J depending on the action;
a third one of the pads is sensitive to a range of user actions that cause the processor to register characters K, L, M, N and O depending on the action;
a fourth one of the pads is sensitive to a range of user actions that cause the processor to register characters P, Q, R, S, and T depending on the action;
a fifth one of the pads is sensitive to a range of user actions that cause the processor to register characters U, V, W, X and Y depending on the action;
detect activation of a selected one of the touch sensitive keys; and
register in memory the character or function corresponding to the selected one of the touch sensitive keys activated.
